(19) United States
(12) Patent Application Publication
(10) Pub. No.: US 2010/0214181 A1
(43) Pub. Date: Aug. 26, 2010

(54) MULTI-BAND ANTENNA AND WIRELESS COMMUNICATION DEVICE INCLUDING THE SAME

(76) Inventors: Byung Hoon Ryou, Seoul (KR); Won Mo Sung, Gyeonggi-do (KR); Jeong Pyo Kim, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/598,596

(22) PCT Filed: Apr. 29, 2008
(86) PCT No.: PCT/KR08/02409

§ 371 Date: Mar. 1, 2010

(30) Foreign Application Priority Data
May 3, 2007 (KR) 10-2007-0043158

(51) Int. Cl. H01Q 5/00; H01Q 9/04; H01Q 1/24

(52) U.S. Cl. 343/702; 343/700 MS

(57) ABSTRACT

There is herein disclosed a multi-band antenna which can adjust respective frequency bands independently. The multi-band antenna comprises a first radiation element having a PIFA structure and a second radiation element having a monopole structure. Also, a second ground terminal is disposed at one end of the first radiation element so as to be connected to a ground plane through a capacitor. The adjustment of the capacitance enables an independent adjustment of a first frequency band. The second radiation element includes a stub so as to allow the second frequency band to be independently adjusted, and a first sub-element and a second sub-element which defines a slit therebetween so as to allow the third frequency band to be independently adjusted. According to the present invention, it is possible to provide a multi-band antenna which can easily adjust respective frequency bands using multi-bands.

### TECHNICAL FIELD

The present invention relates to a multi-band antenna, and more particularly, to a multi-band antenna which can adjust respective frequency bands independently.

### BACKGROUND ART

In wireless communication in which information is transmitted and received by electromagnetic waves, an antenna in which current is directly induced by the electromagnetic waves or the electromagnetic waves are induced by the current should be indispensably included in a wireless communication device as the most distal element of an analog circuit. It is known that the antenna is classified into a dipole antenna, a monopole antenna, etc., in terms of its structure. A portable wireless communication device prefers the monopole antenna which is small-sized. The monopole antenna is designed to have a length corresponding to one fourths of a resonant wavelength, i.e., a wavelength for the center frequency of a target frequency band, due to the mirror effect of a ground surface, such that the larger the wavelength of a use signal becomes, i.e., the smaller the frequency of the use signal becomes, the size of the monopole antenna is increased.

Currently, a miniaturized antenna which can be built in a terminal is widely used, and an inverted L-type antenna (ILA), an inverted F-type antenna (IFA), a planar inverted F-type antenna (PIFA), etc., as modifications of the monopole antenna are widely employed. These antennas basically have a length of corresponding to one fourths of the resonant wavelength as having the same construction as that of the monopole antenna.

In the meantime, the ultra High frequency (UHF) band means a frequency band ranging from 300 to 3000 MHz, and has been generally used in FM radio broadcasting or television broadcasting. Recently, since a mobile broadcasting service, in particular, a digital video broadcasting-handheld (DVB-H) service is designed to use a frequency band ranging from 470 to 862 MHz as the UHF band, a research is actively in progress on a terminal for receiving a signal of the UHF band and antenna used in the terminal.

The terminal is typically constructed to provide the DVB-H service as well as cellular services such as a global system for mobile communication (GSM), a digital cellular system (DCS) and the like. Typically, the GSM900 service employing a frequency band of 900 MHz and the DSC1800 service employing a frequency band of 1.8 GHz can be provided together with the DVB-H service. Since these services are different in use frequency band from each other, the antennas for the services should also have different resonant wavelengths, and a separate antenna is generally used for each service. However, in this case, the manufacturing cost of the antenna is increased and a space occupied by the antenna is also increased, thereby obstructing a miniaturization of the terminal.

A multi-band antenna having more than two frequency bands can be used in order to provide all the services using a single antenna. But, as described above, it is very difficult to implement a multi-band antenna having one or more frequency bands with the center frequencies which are quite different from each other. A multi-band antenna can be relatively easily implemented using a single radiation element for services having the center frequencies which are in a multiplication relation such as the GSM900 and DSC1800 services, but in case of services having the center frequencies which are not in a multiplication relation such as the GSM900 and DVB-H services or the DCS1800 and DVB-H services and are spaced apart from each other, it is difficult to implement an antenna capable of covering all of them.

In addition, even in case of actually implementing the multi-band antenna, the antenna is not operated independently with respect to respective frequency bands, but a change in operation characteristics in one frequency band has an influence on the operation characteristics in another frequency band. Thus, a fine tuning of the antenna becomes difficult, and it is very difficult to properly install the antenna at diverse terminals whose electromagnetic installation environments are different.

### DISCLOSURE OF INVENTION

### Technical Problem

Accordingly, the present invention has been made to overcome the above-mentioned problems occurring in the prior art, and it is an object of the present invention to provide a multi-band antenna which has two or more frequency bands so as to provide different two or more services.

Another object of the present invention is to provide a multi-band antenna which can independently adjust two more frequency bands to enable an easy fine tuning of the antenna and can be easily installed at diverse terminals.

### Technical Solution

To accomplish the above objects, according to one aspect of the present invention, there is provided a multi-band antenna, a first radiation element including a feed terminal connected to a feed element, a first ground terminal connected to a ground plane and a second ground terminal, and the first radiation element being adapted to cover a first frequency band; and a second radiation element connected at one end to the feed terminal so as to be substantially operated as a monopole antenna, the second radiation element being adapted for covering a second frequency band, wherein the second ground terminal of the first radiation element is connected to the ground plane by means of a capacitor.

The first ground terminal and the second ground terminal may be formed at both ends of the first radiation element. Also, the capacitor may be a variable capacitor.

Preferably, the first radiation element may include a horizontal radiation element disposed in substantially parallel with the ground plane and a vertical radiation element disposed substantially perpendicular to the ground plane.

In addition, preferably, the second radiation element may include a first sub-element connected at one end thereof to the feed element, and a connecting portion connected to the other end of the first sub-element, and a second sub-element connected to the connecting portion in such a fashion as to be spaced apart from the first sub-element and extend in substantially parallel with the first sub-element. The second radiation element may further include a stub extendedly formed at one side of the connecting portion.

In the meantime, preferably, the ground plane may not be formed at an area where the first radiation element and the second radiation element are disposed.

The first frequency band may be a frequency band used in a DVB-H service, and the second frequency band may be a frequency band used in a GSM900 service.

Also, the second radiation element may further cover a third frequency band as a multiplied frequency band of the second frequency band, and the third frequency band may be a frequency band used in a DCS1800 service.

In the meantime, the multi-band antenna may further include a dielectric element for supporting the first radiation element and the second radiation element. In this case, preferably, the first radiation element and the second radiation element may be disposed on different surfaces of the dielectric element.

According to another aspect of the present invention, there is also provided a wireless communication device including the multi-band antenna.

### Advantageous Effects

According to the present invention, the multi-band antenna has two or more frequency bands so as to provide different two or more services.

Further, according to the present invention, the multi-band antenna can independently adjust two more frequency bands to enable an easy fine tuning of the antenna and can be easily installed at diverse terminals.

### BRIEF DESCRIPTION OF THE DRAWINGS

FIG. 1 is a perspective view showing a multi-band antenna in accordance with an embodiment of the present invention;

FIG. 2 is a top plan view showing a second radiation element of a multi-band antenna in accordance with an embodiment of the present invention;

FIG. 3 is a graph showing the relationship between a return loss and a frequency according to a change in capacitance in a multi-band antenna in accordance with an embodiment of the present invention;

FIG. 4 is a graph showing the relationship between a return loss and a frequency according to a change in length of a stub in a multi-band antenna in accordance with an embodiment of the present invention; and

FIG. 5 is a graph showing the relationship between a return loss and a frequency according to a change in length of a slit in a multi-band antenna in accordance with an embodiment of the present invention.

### BEST MODE FOR CARRYING OUT THE INVENTION

A preferred embodiment of the present invention will now be described in detail to with reference to the attached drawings. This is merely an exemplary embodiment, and the present invention is not limited thereto.

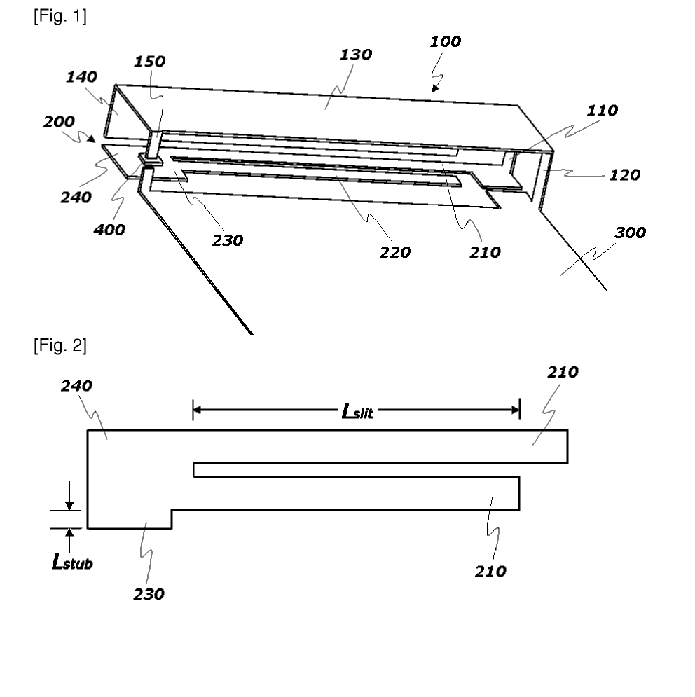

FIG. 1 is a perspective view showing a multi-band antenna in accordance with an embodiment of the present invention.

In this embodiment, the multi-band antenna includes a first radiation element 100 for covering a first frequency band and a second radiation element 200 for covering a second frequency band, which are all disposed at one side of a ground plane 300 so as to be fed with power.

In the meantime, the antenna may further include a dielectric element (not shown) for supporting the first and second radiation elements 100 and 200 and facilitating the installation of the antenna. In this case, the first radiation element 100 and the second radiation element 200 can be displaced on different surfaces of the dielectric element, preferably on the top surface and the bottom surface of the dielectric element.

A ground plane 300 is a ground plane positioned inside the terminal, and may be included inside a substrate or may be provided separately. The ground plane 300 is not formed in a position where the first and second radiation elements 100 and 200 are disposed so as to prevent the radiation of the first and second radiation elements 100 and 200 from being hindered.

The first and second radiation elements 100 and 200 may be formed by press-machining a metal plate, or plating, depositing and printing a conductive material on the dielectric element. Also, the radiation elements 100 and 200 may be formed by a metallization technique which is known as a laser direct structuring (LDS). Besides these methods, the radiation elements 100 and 200 may be manufactured in diverse manners, and the present invention is not limited to a specific manufacturing method thereof.

The first radiation element 100 basically includes a feed terminal 110 and a first ground terminal 120 as PIFA type antennas at one end thereof. The first ground terminal 120 is connected to a ground plane 300 so as to allow the antenna to be grounded. In the meantime, the feed terminal 110 can be connected to a feed element (not shown) positioned inside a terminal. The feed terminal 110 and the first ground terminal 120 are disposed perpendicular to a plane including the ground plane 300. A horizontal radiation element 130 is substantially disposed in parallel with a plane including the ground plane 300 so as to be connected to the feed terminal 110 and the first ground terminal 120. Also, a vertical radiation element 140 extends downwardly from a side of horizontal radiation element 130 in order to increase a radiation area. In this embodiment, in order to implement a maximum radiation area within a given antenna formation space, the horizontal radiation element 130 and the vertical radiation element 140 are connected to each other, but the vertical radiation element 140 may not be formed depending on specific requirements and an additional radiation element may be further formed.

To the other end of the horizontal radiation element 130, i.e., to an opposite side to a connection portion of the first ground terminal 120, is connected a second ground terminal 150, so that the second ground terminal 150 is connected to the ground plane 300 by means of a capacitor 400. The capacitor 400 serves to provide a capacitance to the antenna so as to affect the resonant characteristics in the first frequency band. Thus, it is possible to adjust the resonant characteristics of the antenna by the adjustment of the capacitance of the capacitor 400. Preferably, a variable capacitor, for example, a varactor diode can be used as the capacitor 400 so as to facilitate the adjustment of the antenna characteristics.

The second radiation element 200, which is an antenna of a folded monopole type, is fed with power at one end thereof and is opened at the other end thereof. More specifically, the second radiation element 200 includes a first sub-element 210 connected at one end thereof to the feed element (not shown) of the terminal, a connecting portion 240 connected to the other end of the first sub-element 210 and a second sub-element 220 connected to the connecting portion 240. The first sub-element 210 may extend in such a fashion as to be connected to the feed terminal 110 of the first radiation element 100.

Referring to FIG. 2, the first sub-element 210 and the second sub-element 220 extend in substantially parallel with each other to define a slit therebetween. Since an electromagnetic coupling due to the slit allows a resonant wavelength, a bandwidth, etc., of the antenna to be changed, the length (Lₛₗᵢₜ) of the slit, i.e., the size of the connecting portion 240 can be adjusted to enable a fine tuning of the antenna. In addition, a stub 230 is extendedly formed at one side of the connecting portion 240. The stub 230 can serve to impart a change to an electrical length of the second radiation element 200 to have an influence on the resonant characteristics of the antenna, and its size can be adjust to conduct a fine tuning of the antenna. The fine tuning of the antenna by the sit and the stub will be described alter.

In the meantime, the second radiation element 200 can cover a third frequency band through resonance of a multiplied frequency. For example, in case of the second frequency band is a global system for mobile communication (GSM)900 band of 900 MHz, the third frequency band may be a DSC1800 band of 1.8 GHz as a multiplication frequency band of the GSM900 band. The first frequency band which can be covered by the first radiation element 100 having a relatively large length as compared to the second radiation element 200 may be a frequency band lower than the second frequency band, for example, a frequency band used in a digital video broadcasting-handheld (DVB-H) service as UHF-IV/V band. Thus, a multi-band antenna is provided which can all provide three services by this embodiment.

Moreover, according to the antenna of this embodiment, the adjustment of respective frequency bands can be performed independently.

As described above, the adjustment of the first frequency band is conducted by the adjustment of the capacitor 400. The adjustment of the capacitor 400 has an influence on only the electromagnetic characteristics of the first radiation element 100, but not on the second radiation element 200 which is not connected to the capacitor 400. Therefore, the second and third frequency bands are not affected by any change of the first frequency band due to the adjustment of the capacitor 400.

The adjustment of the second frequency band is performed by the adjustment of the length (L_{stub}) (see FIG. 2) of the stub 230. The second radiation element 200 is operated as a ¼ antenna for the second frequency band, such that if the length (L_{stub}) of the stub 230 is adjusted to conduct a fine adjustment of the electrical length of the antenna, the antenna characteristics in the second frequency band can be finely tuned. The change in electrical length of the second radiation element 200 does not have an influence on the electrical length of the first radiation element 100. Since the first radiation element 100 has a large capacitance component with an aid of the capacitor 400, its electrical characteristics are not changed despite a change of the second radiation element 200. In addition, the second radiation element 200 is operated as a ¾ antenna for the third frequency band, such that an influence of a fine change of electrical length thereof is much less on the third frequency band than on the second frequency band. Ideally, the influence of the fine change of electrical length of the second radiation element 200 on the third frequency band is one thirds that of the fine change of electrical length of the second radiation element on the second frequency band. Accordingly, the second frequency band can be easily adjusted without affecting other frequency bands.

Lastly, the adjustment of the third frequency band can be performed by the adjustment of the length (Lₛₗᵢₜ) (see FIG. 2) of the slit.

Since the slit is defined by an interval spaced between the first sub-element 210 and the second sub-element 220, its size can be adjusted to control a degree of electromagnetic coupling between the first and second sub-elements 210 and 220. Since such electromagnetic coupling gives a greater influence at a high frequency, the adjustment of a degree of the electromagnetic coupling by the length (Lₛₗᵢₜ) of the slit mainly has an influence on the third frequency band, but not the second frequency band greatly. Also, as stated above, since a change in electromagnetic characteristics of the second radiation element 200 does not have an influence on the antenna characteristics by the first radiation element 100, the adjustment of the length (Lₛₗᵢₜ) of the slit affects only the third frequency band. Thus, the third frequency band can also be easily adjusted without affecting other frequency bands.

Like this, the adjustment effect of the first to third frequency bands was tested through the actual implementation of the antenna. In the implemented antenna, the first to third frequency bands were set such that the first frequency band is a DVB-H band, the second frequency band is a GSM900 band and the third frequency band is a DSC1800 band.

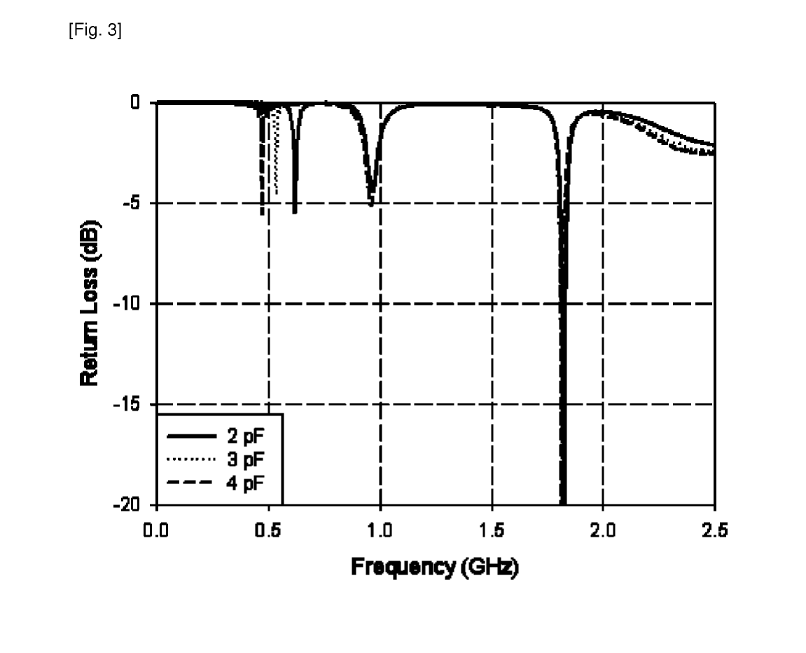

FIG. 3 is a graph showing the relationship between a return loss and a frequency according to a change in capacitance in a multi-band antenna in accordance with an embodiment of the present invention.

As shown in FIG. 3, the resonant wavelength of the antenna was changed at about 500 MHz as the DVB-H band due to an increase in a capacitance component according to the change of the capacitance from 2 pF to 4 pF. But, there was nearly no change of the resonant wavelength of the antenna at about 900 MHz as the GSM900 band and about 1.8 GHz as the DSC1800 band. Thus, it could be found that the first frequency band could be independently adjusted by the adjustment of the capacitance.

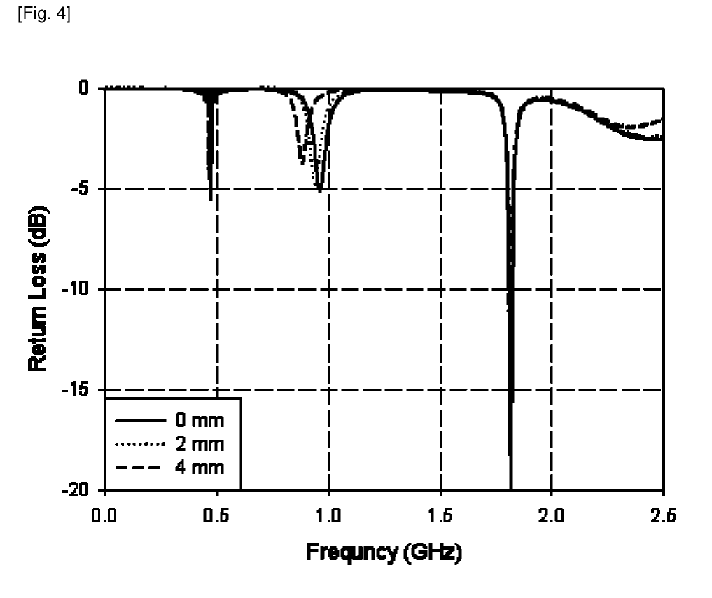

FIG. 4 is a graph showing the relationship between a return loss and a frequency according to a change in length of a stub in a multi-band antenna in accordance with an embodiment of the present invention.

As shown in FIG. 4, it was observed that the resonant wavelength of the antenna was decreased at about 900 MHz due to an increase in the electrical length of the second radiation element according to the change of the length of the stub from 0 mm to 4 mm. But, it could be found that there was no change of the resonant wavelength of the antenna at about 500 MHz and 1.8 GHz, and the second frequency band could be independently adjusted by the adjustment of the length of the stub.

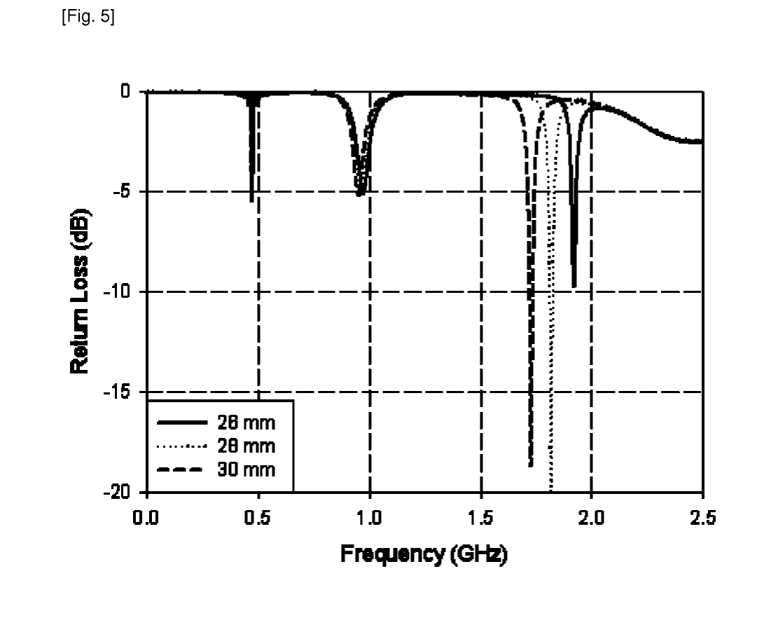

FIG. 5 is a graph showing the relationship between a return loss and a frequency according to a change in length of a slit in a multi-band antenna in accordance with an embodiment of the present invention.

As shown in FIG. 5, it was observed that the resonant wavelength of the antenna was decreased at about 1.8 GHz due to an increase in a degree of electromagnetic coupling at the second radiation element as well as an increase in a capacitance component according to the change of the length of the slit from 26 mm to 30 mm. But, it could be found that there was substantially no change of the resonant wavelength of the antenna at about 500 MHz and about 900 MHz, and the third frequency band could be independently adjusted by the adjustment of the length of the slit.

While the preferred embodiment in accordance with the present invention has been described above, it is merely an exemplary embodiment and the present invention is not limited thereto. It will be apparent to those skilled in the art that the embodiment of the present invention can be changed or modified to have other specific forms without departing from the scope and spirit of the invention, other than the above-described embodiment. Therefore, the scope of the invention should be defined by only the appended claims and their equivalents, but not the above-mentioned embodiment.

1. A multi-band antenna comprising:
a first radiation element including a feed terminal connected to a feed element, a first ground terminal connected to a ground plane and a second ground terminal, and the first radiation element being adapted to cover a first frequency band; and
a second radiation element connected at one end to the feed terminal so as to be substantially operated as a monopole antenna, the second radiation element being adapted for covering a second frequency band,
wherein the second ground terminal of the first radiation element is connected to the ground plane by means of a capacitor.

2. The multi-band antenna according to claim 1, wherein the first ground terminal and the second ground terminal are formed at both ends of the first radiation element.

3. The multi-band antenna according to claim 1, wherein the capacitor may be a variable capacitor.

4. The multi-band antenna according to claim 1, wherein the first radiation element comprises a horizontal radiation element disposed in substantially parallel with the ground plane and a vertical radiation element disposed substantially perpendicular to the ground plane.

5. The multi-band antenna according to claim 1, wherein the second radiation element comprises a first sub-element connected at one end thereof to the feed element, and a connecting portion connected to the other end of the first sub-element, and a second sub-element connected to the connecting portion in such a fashion as to be spaced apart from the first sub-element and extend in substantially parallel with the first sub-element.

6. The multi-band antenna according to claim 5, wherein the second radiation element further comprises a stub extendedly formed at one side of the connecting portion.

7. The multi-band antenna according to claim 1, wherein the ground plane is not formed at an area where the first radiation element and the second radiation element are disposed.

8. The multi-band antenna according to claim 1, wherein the first frequency band is a frequency band used in a DVB-H service.

9. The multi-band antenna according to claim 1, wherein the second frequency band is a frequency band used in a GSM900 service.

10. The multi-band antenna according to claim 1, wherein the second radiation element further covers a third frequency band as a multiplied frequency band of the second frequency band.

11. The multi-band antenna according to claim 10, wherein the third frequency band is a frequency band used in a DCS1800 service.

12. The multi-band antenna according to claim 1, further comprising a dielectric element for supporting the first radiation element and the second radiation element, wherein the first radiation element and the second radiation element are disposed on different surfaces of the dielectric element.

13. A radio communication device comprising a multi-band antenna comprising:
a first radiation element including a feed terminal connected to a feed element, a first ground terminal connected to a ground plane and a second ground terminal, and the first radiation element being adapted to cover a first frequency band; and
a second radiation element connected at one end to the feed terminal so as to be substantially operated as a monopole antenna, the second radiation element being adapted for covering a second frequency band,
wherein the second ground terminal of the first radiation element is connected to the ground plane by means of a capacitor.
